(19) United States
(12) Patent Application Publication
(10) Pub. No.: US 2008/0313942 A1
(43) Pub. Date: Dec. 25, 2008

(54) Viewer

(76) Inventor: Oliver Heine, Oberraden (DE)

Correspondence Address: BROOKS KUSHMAN P.C., 1000 TOWN CENTER, TWENTY-SECOND FLOOR, SOUTHFIELD, MI, 48075, US

(21) Appl. No.: 12/067,097

(22) PCT Filed: Sep. 13, 2006
(86) PCT No.: PCT/DE06/01628

§ 371 Date: Aug. 12, 2008

(30) Foreign Application Priority Data
Sep. 15, 2005 (DE) 10 2005 044 056.8

(51) Int. Cl. G09F 19/00

(52) U.S. Cl. 40/470

(57) ABSTRACT

The invention relates to a viewer having a housing which has a front wall and a rear wall, wherein the front wall has at least one viewing opening for viewing an image which is depicted on an image carrier inside the housing. In order to make it possible to optimally depict the image motifs on the image carrier in a simple manner, the invention proposed providing at least one drive device, which acts on the image carrier, in the housing such that the position of the image carrier with respect to the viewing opening can be changed from a first end position to a second end position and vice versa.

The invention relates to a viewing device with a housing having a front wall and a rear wall, the front wall having at least one viewing opening for viewing an image displayed in the interior of the housing on an image carrier.

WO 2005/051141 A1 discloses a viewing device of the abovementioned type in the case of which in order to generate a spatial impression of the flat image subjects located on the image carrier, the latter is arranged on the inner surface, curved away from the viewer, of the rear wall of the housing, and the outer surface of the front wall of the housing is curved toward the viewer.

Since the curvatures of the rear and front walls are generally permanently prescribed, such a known viewing device does not permit the viewing form of the image subjects that are to be viewed to be respectively better adapted to the given spatial and viewing conditions, or to be changed. This is the case, in particular, with advertising displays or LCD flat screens in the case of which, for example, the aim is to enhance the spatial impression of the displayed image subjects, something which can, however, be realized only with difficulty because of the light conditions and the viewing angle.

It is the object of the present invention to specify a viewing device that in a simple way permits an optimum display of the image subjects located on the image carrier in one and the same unit.

This object is achieved according to the invention by the features of claim 1. Further, particularly advantageous refinements of the invention are disclosed by the subclaims.

The invention is based in essence on the idea of providing in the housing of the viewing device at least one drive device that acts on the image carrier in such a way that the position of the image carrier can be changed with reference to the viewing opening from a first end position into a second end position, and vice versa.

Owing to the possibility of changing the position of the image carrier by means of a drive device, it is possible for the pictorial representation to be optimally adapted to the respective viewer even if the housing of the viewing device is already located at a fixed location.

Furthermore, a continuously moving change of the image carrier can make the viewer highly attentive, and this is advantageous, in particular, for displays of advertising information on an image carrier for the purpose of sales promotion of the displayed products.

In the case of a first embodiment of the invention, it is provided in order to enhance or diminish the spatial effect of the image subjects that at least two opposite edge regions of the image carrier are held by a holding device in such a way that the drive device can change the curvature of the image carrier with reference to the viewing opening, the edge regions of the image carrier that are displaced laterally during a change in the curvature being held either by a guide of the holding device or by an elastic element.

In a second embodiment of the invention, it is provided that at least two opposite edge regions of the image carrier are respectively held by a holding device of rotary design in such a way that in the event of simultaneous rotation of the holding devices in an opposite sense of rotation the curvature of the image carrier can be changed with reference to the viewing opening.

In the case of a third embodiment of the invention, at least two opposite edge regions of the image carrier are respectively held by a holding devices, said holding devices being designed in a fashion capable of mutual displacement in the direction of the longitudinal axis of the image carrier in such a way that in the event of displacement of the holding devices toward one another the curvature of the image carrier can be changed with reference to the viewing opening.

In a modification of this embodiment, it is provided that it is not the edge regions of the image carrier itself, but a transparent, plate-shaped element, arranged on the outside, that is supported in displaceable holders, provided at the sides. When the holders are displaced toward one another, this element then presses on the outside against the image carrier so that the curvature of the image carrier changes with reference to the viewing opening into the interior of the housing.

In the case of a fourth embodiment of the invention, it is provided that in order to emphasize the depth effect of an image subject, the image carrier is supported inside the housing of the viewing device in such a way that it is displaced as a whole by the drive device away from the viewing opening or toward the viewing opening.

In the case of a fifth embodiment of the invention, the drive device comprises three drives, two drives respectively being fastened in opposite edge regions of the image carrier, one drive being fastened on the image carrier in the middle region thereof. Both a parallel displacement and a change in curvature of the image carrier can be produced with the aid of such a viewing device. Furthermore, the image carrier can adopt an oblique position with reference to the housing of the viewing device, or only the edge regions of the image carrier can be curved and the remaining region of the image carrier be of plane design when the drive acting on the middle region of the image carrier comprises a plate-shaped actuator.

It has proved to be particularly advantageous when the drive device is an electric motor drive with an actuator. In this case, the setting of the optimum position of the image carrier can be performed, for example, by means of a remote control from the location of the viewer.

The actuator can be, for example, a zoom mechanism acting on the middle region of the rear side of the image carrier. However, it can also be a slide mechanism (linear guide) acting on the middle, lower or upper edge region of the image carrier.

In the case of simpler embodiments of the inventive viewing device (for example displaying a photograph in a picture frame), the drive device can be a device that can be actuated from outside the housing. Here, for example, an eccentric pressing on the inside against the image carrier can be rotated with the aid of an adjusting wheel partially guided outward.

Furthermore, it has proved to be advantageous to use as drive device a stiff, flat metal or plastic band that is guided through a guide fastened on the rear side of the image carrier and is fastened at one of its ends in a holding device fixed to the housing, and is arranged at its other end such that it can be wound up and/or unwound by a winding mechanism.

A very simple drive device comprises a Bowden cable, the core of the Bowden cable being connected to a fastening device arranged on the rear side of the image carrier. When use is made of a Bowden cable, this can be connected in a simple way to corresponding motor or manual control elements that can be located either on or in the housing of the viewing device, or at another location.

The drive device can, however, be a magnetically operating device in which there is provided an electromagnet that acts on at least one magnetic element that either is formed by the image carrier (for example the shadow mask of a conventional screen device) itself, or is arranged on the rear side of the image carrier or on the lateral end regions of the image carrier. Such drive devices are suitable, in particular, for viewing devices in which the image carrier is located in a hermetically sealed space and thus, in particular, for screen carriers located in vacuo.

Furthermore, the drive devices can be fluidic drives in which, for example, flexible pressure containers of cushion-shaped design are used to change the position of the image carrier. Here, the image carrier can be driven by the corresponding “pressure cushion” both from the rear side and from the front side of the image carrier.

In the case of driving of the image carrier from the rear side, the “pressure cushion” can act on the image carrier directly or via a separate actuator. In the case of driving of the image carrier from the front side, it is either possible to use a separate transparent “pressure cushion” that extends in planar fashion over the entire surface of the image carrier, or the image carrier itself forms a flexible wall of the “pressure cushion”. The wall of this pressure cushion that is opposite the image carrier can then be formed by the front wall—transparent in the region of the viewing opening—of the viewing device.

When use is made of such fluidic drive devices, the latter can be driven in a very simple way with corresponding motor and/or manual control elements that can be located either on or in the housing of the viewing device, or else at another location.

In order to ensure a stable end position of the image carrier, for example, while the viewing device is being transported, it has proved to be expedient when provided in the housing of the viewing device is a stop surface that is arranged in the vicinity of the rear wall and against which the image carrier bears in a form-fitting fashion in its first end position. Furthermore, the front wall can also be designed as front stop surface of the image carrier against which the image carrier bears in a form-fitting fashion in its second end position.

The image carrier can be a flat screen consisting of elastic material. However, other image carriers also come into consideration.

In a way similar to that in the abovementioned WO 2005/051141 A1, it can be provided that the image carrier can be illuminated by at least one light source that can be arranged inside the housing. Here, in the case of an image carrier made from a transparent material, said image carrier can also be illuminated from the rear side of the housing.

Further details and advantages of the invention emerge from the following exemplary embodiments explained with the aid of figures, in which:

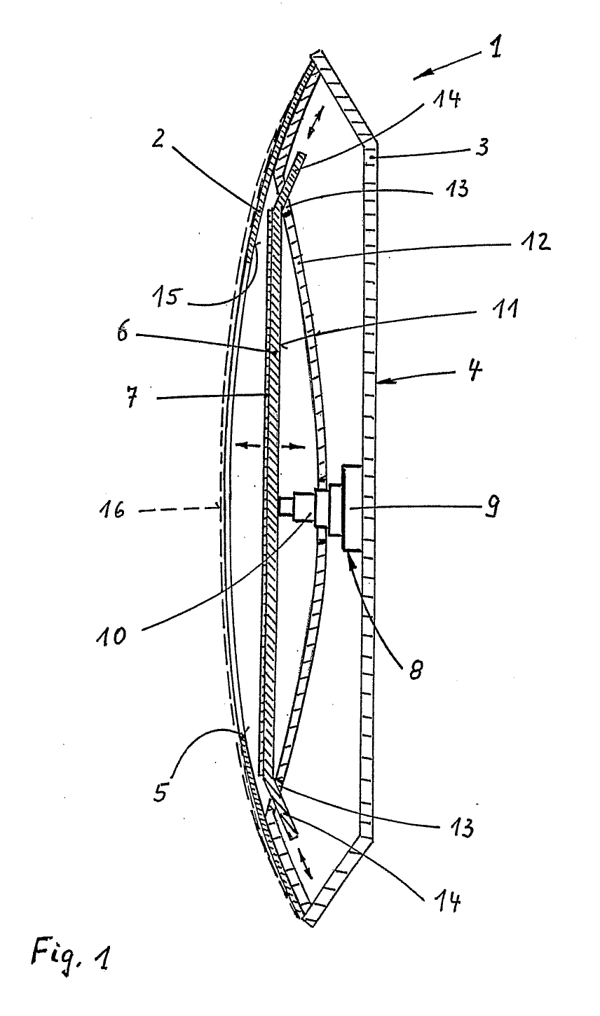

FIG. 1 shows (in plan view) the cross section through a first exemplary embodiment of an inventive viewing device with an electric motor drive for changing the position of the image carrier, the drive device acting on the image carrier in the middle region;

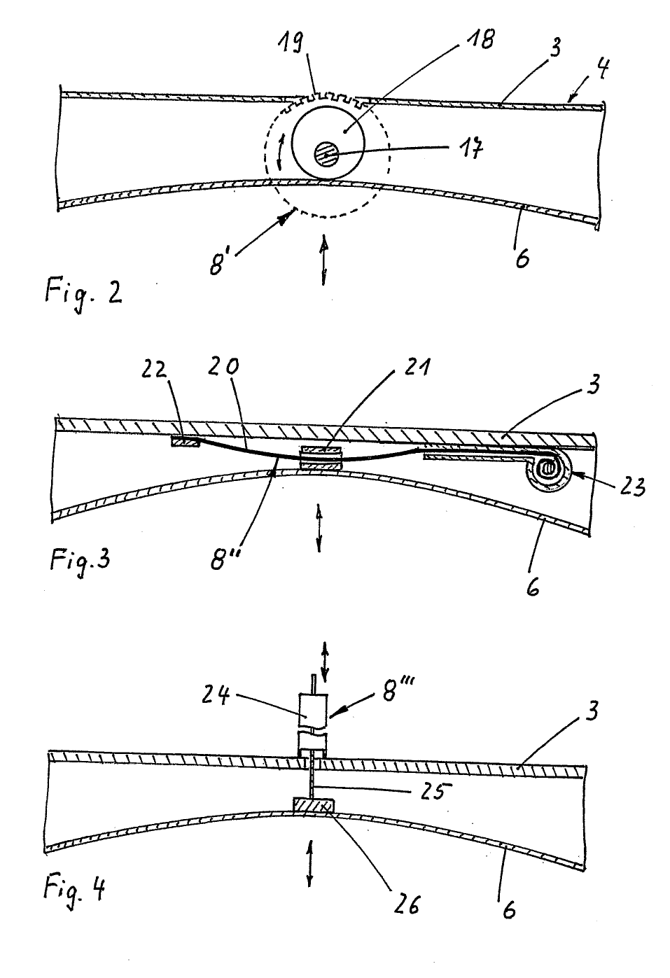

FIGS. 2-5 show four further partially schematic illustrations of different exemplary embodiments of inventive viewing devices, the drive devices likewise acting on the middle region of the respective image carrier;

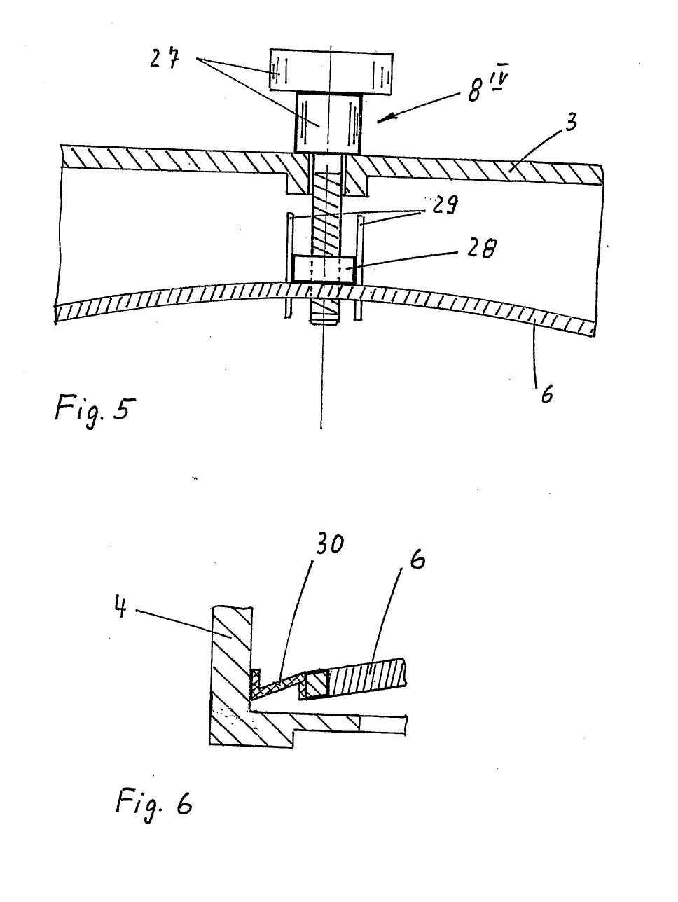

FIG. 6 shows a schematic of a possible edge fastening of an image carrier by means of an elastic element;

FIGS. 7-9 shows three schematics of an exemplary embodiment in the case of which a drive device is provided with three drives that act on the image carrier both at the edges and in the middle region thereof;

FIG. 10 shows a schematic of an inventive viewing device with holding devices of the image carrier that are of rotary design and arranged at the sides;

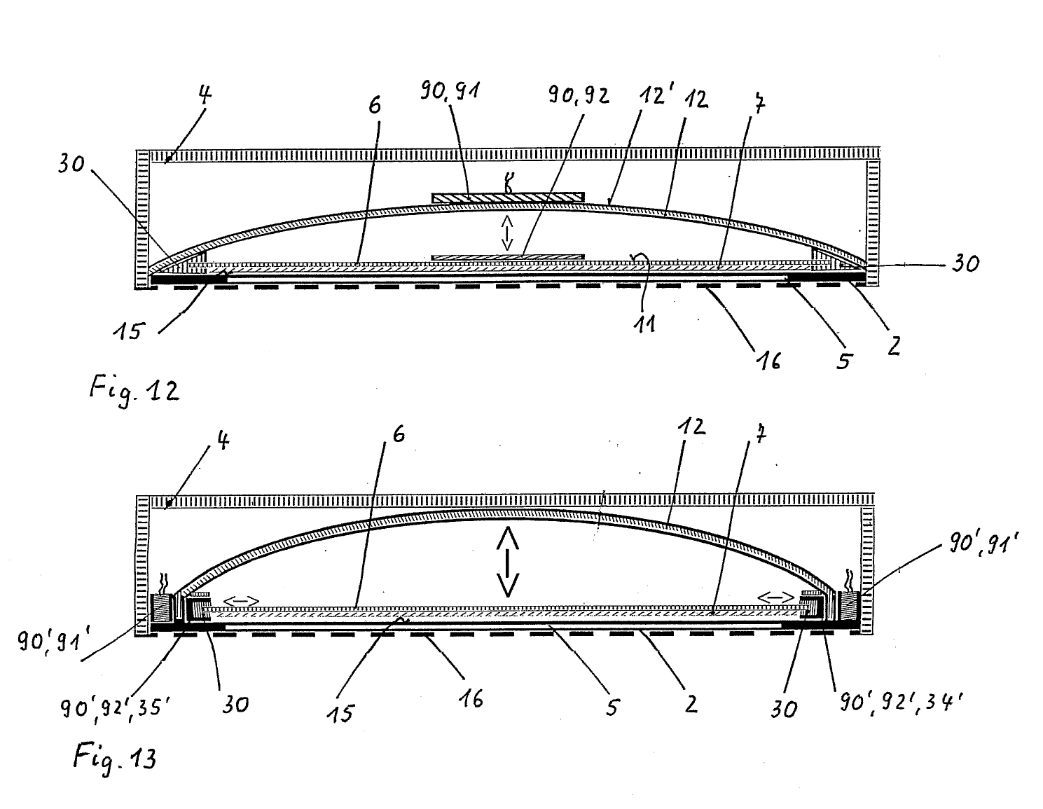

FIG. 11 shows a schematic in the case of which a transparent plate-shaped actuator presses against the image carrier from outside, it being possible to actuate the actuator by two holders thereof that are arranged at the sides on the housing of the viewing device and that are of displaceable design;

FIG. 12 shows a schematic of an inventive viewing device with an electromagnetic drive device, a corresponding electromagnet acting on a magnetic actuator arranged on the rear side of the image carrier;

FIG. 13 shows a view corresponding to FIG. 12, the electromagnet acting on at least one actuator arranged on the lateral edge region of the image carrier;

FIG. 14 shows a schematic of an inventive viewing device with a fluidic drive device, the change in position of the image carrier being performed from its front side with the aid of a “pressure cushion”; and

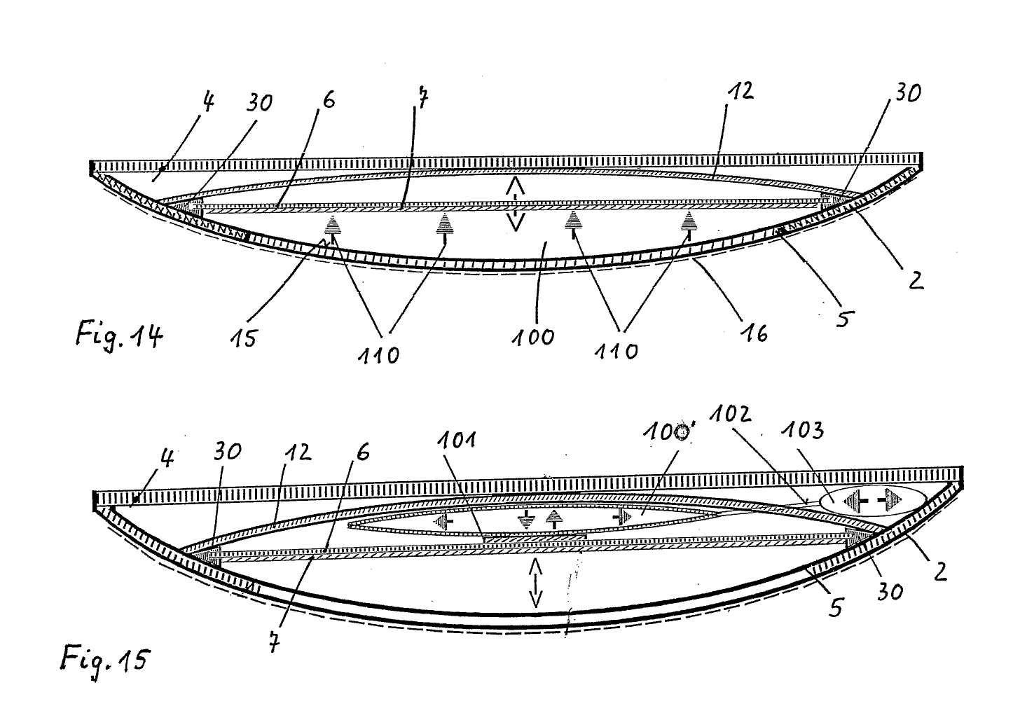

FIG. 15 shows an illustration corresponding to FIG. 14, the changing position of the image carrier being performed from its rear side by means of a “pressure cushion”.

An inventive viewing device that is, for example, a flat OLED screen is denoted by 1 in FIG. 1. The drive electronics for the image screen have not been illustrated here, for reasons of clarity.

The viewing device 1 comprises a housing 4 having a front wall 2 and a rear wall 3, the front wall 2 having a viewing opening 5 for viewing an image 7 displayed in the interior of the housing 4 on an image carrier 6 (generally square or rectangular).

In the example illustrated, the image carrier 6 is a separate carrier film made from an elastic material, on the front of which is applied a screen film 7 with OLED display (not illustrated) that reproduces the image information. However, the film facing the rear wall 3 can also serve as image carrier given appropriately stably designed screen films.

According to the invention, the viewing device 1 comprises a drive device 8 that acts on the image carrier 6 and comprises an electric motor drive 9 and an actuator 10. The drive device 8 acts on the middle region of the rear side 11 of the image carrier 6 in such a way that the position of the image carrier 6 can be changed with reference to the viewing opening 5 from a first end position into a second end position. In this case, in FIG. 1 the image carrier 6 is located in a middle, intermediate position located between the first and second end positions.

The viewing device 1 further includes a stop surface 12 that is arranged in the vicinity of the rear wall 3 and is curved toward the rear wall 3, and on which the image carrier 6 rests in its first end position and thus has a concave curvature. At the edges, the stop surface 12 extends up to the front wall 2 and reinforces the latter.

In the vicinity of the front wall 2, the stop surface 12 includes slot-shaped openings 13 through which the edge regions 14 of the image carrier 6 are plugged. The stop surface 12 therefore serves both as holding device for laterally holding the image carrier, and for the lateral guidance of the image carrier 6 when the curvature of the image carrier 6 and thus also the lateral position of the edge regions 14 of the image carrier 6 change upon actuation of the drive device 8.

In the second end position, the image carrier 6 rests on the inner side 15 of the front wall 2.

As indicated by a dashed line in FIG. 1, the viewing opening can be provided by an additional transparent cover film 16 or a glass pane for protecting the image carrier 6.

In the exemplary embodiment illustrated in FIG. 1, the drive device 8 is a zoom mechanism known per se such as is used, for example, in electronic cameras.

Of course, other drive devices can also be used.

Thus, for example, FIG. 2 illustrates a drive device 8′ with an eccentric mechanism. This comprises an eccentric 18 that can rotate about an axis of rotation 17 and which in the present case can be rotated both by an electric motor drive (not illustrated) and manually by an adjusting wheel 19. The eccentric 18 acts on the rear side of the image carrier 6 and spaces the latter toward the viewer from its position prestressed by a resetting element (not illustrated).

A further exemplary embodiment of a drive device is shown in FIG. 3. Here, it is proposed to use as drive device 8″ a stiff, flat metal or plastic band 20 that is guided through a guide 21 fastened on the rear side of the image carrier 6 and is fastened at one of its ends in a holding device 22 fixed to the housing, and is arranged at its other end such that it can be wound up and/or unwound manually or by motor by a winding mechanism 23.

A very simple drive device is illustrated in FIG. 4. This drive device 8′″ comprises a Bowden cable 24 the end of the core 25 of the Bowden cable 24 being connected to a fastening device 26 arranged on the rear side of the image carrier 6.

When use is made of a Bowden cable 24, the latter can easily be connected to corresponding motorized or manual control elements that can be located either on or in the housing 4 of the viewing device or also at another location.

As may be gathered from FIG. 5, the drive device 8^{IV} for the image carrier 6 can also comprise an electric motor spindle drive 27 in which the spindle nut 28 is designed as a slide that can be displaced along a guide 29. Here, the slide 28 moved by motor acts on the lower and/or upper edge region of the image carrier 6 and displaces the latter, the slide 28 preferably being arranged in such a way that it cannot be seen by a viewer of the image information displayed on the image carrier 6.

As may be gathered from FIG. 6, the holding device 12, illustrated in FIG. 1, with the slot-shaped openings 13 for connecting the edge of the image carrier 6 to the housing 4 can also be replaced by elastic elements 30 arranged at the edge such as a rubber lip, a foam rubber bearing or a folded edge region (frequent use in the case of loudspeakers).

Of course, the drive device need not comprise only a single drive, and the respective drive need not necessarily act on the image carrier in the middle region via an actuator.

Thus, FIGS. 7-9 illustrate an exemplary embodiment in which the illustrated drive device 80 comprises three drives 81, 82, 83. Here, the drives 81 and 82 respectively act on the edge region of the image carrier 6, and the drive 83 acts on the middle region of the image carrier 6, the drives 81-83 respectively effecting a displacement of the image carrier 6 substantially perpendicular to the longitudinal axis thereof.

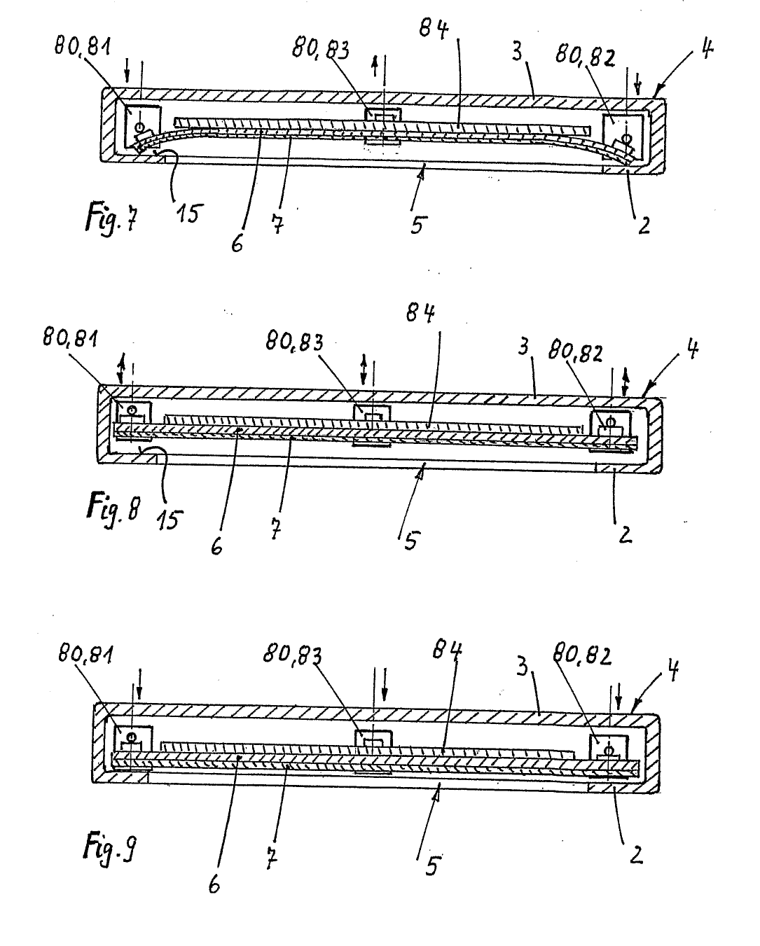

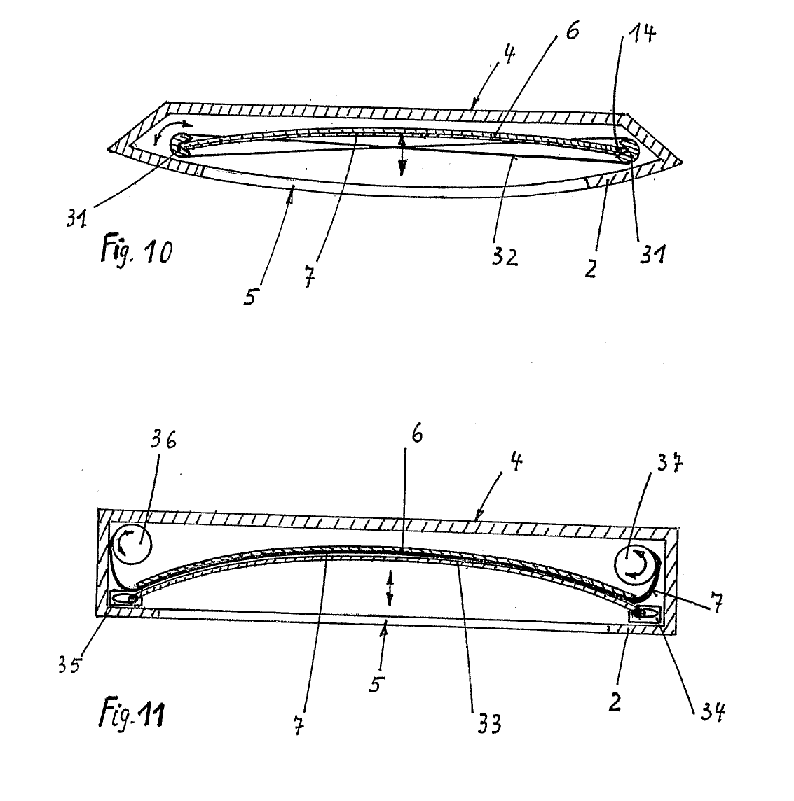

Such a viewing device can be used to undertake a parallel displacement of the image carrier 6 (FIGS. 8 and 9) such that the entire flat planar image carrier 6 is displaced from the inner side 15 of the front wall 2 into the interior of the housing 4, in order to achieve an image display similar to a stage setting.

However, it is also possible to produce a change of curvature of the image carrier 6 (FIG. 7). Here, it is also possible for only the edge regions of the image carrier 6 to be curved while the remaining region of the image carrier 6 is flat if the drive 83 acting on the middle region of the image carrier 6 comprises a plate-shaped actuator 84 (FIG. 7). Furthermore, when the drives 81-83 are driven appropriately the image carrier 6 can also assume an oblique position with reference to the housing 4 of the viewing device.

FIG. 10 shows an inventive viewing device in which two opposite edge regions of the image carrier 6 are respectively held by a holding device 31 of rotary design in such a way that in the event of simultaneous rotation of the holding device 31 in an opposite sense of rotation the curvature of the image carrier 6 can be changed with reference to the viewing opening 5. A drive element 32 (rubber band, toothed belt etc.) interconnects two holding devices 31 in order in this case to ensure simultaneous rotation of the holding devices 31.

FIG. 11 illustrates an inventive viewing device in the case of which a transparent, plate-shaped element 33 arranged on the outside with reference to the image carrier 6 is supported in displaceable holders 34, 35 arranged at the edge. Upon displacement of the holders 34, 35 toward one another, the element 33 then presses on the outside against the image carrier 6 such that the curvature of the image carrier 6 changes with reference to the viewing opening 5.

This viewing device is particularly advantageous when the image 7 to be displayed is, for example, a film that is wound up or unwound by corresponding spools 36, 37. The reason for this is that in this case after the film has been displayed the purpose of quickly rewinding the film onto one of the spools can be served by displacing the plate-shaped element 33 into its initial position so that it does not touch the film (or, as the case may be, an additional guide or protective foil of the film etc.), and its wear is kept low by avoiding friction with the element 33.

Of course, the invention is not restricted to the exemplary embodiments described above. Thus, the lateral holders illustrated in FIG. 11 can also act directly on the image carrier and cause a corresponding change in the curvature of the image carrier.

Furthermore, the image denoted by the reference numeral 7 need not be a separate body (for example in the form of a film or a paper strip), but it can also be an image projected onto the image carrier by means of a projector so that the image carrier is an irradiatable or transirradiatable image projection surface (flexible projection screen, plastic surface, mirror surface etc.).

Again, the drive device need not necessarily be designed in such a way that the image carrier is displaced symmetrically, rather it is also possible for the image carrier to change asymmetrically, something which can be of particular advantage whenever the viewer views the images displayed on the image carrier from the side.

Furthermore, the drive device can be a device which operates magnetically and is provided with an electromagnet that acts on at least one magnetic element that either is formed by the image carrier (for example the shadow mask of a conventional screen device) itself, or is arranged on the rear side of the image carrier or on the lateral edge regions of the image carrier.

Two corresponding exemplary embodiments are illustrated in FIGS. 12 and 13

Here, FIG. 12 shows a viewing device in which there is provided a drive device 90 that comprises a schematically illustrated electromagnet 91, arranged on the rear side 12′ of the stop surface 12, and a magnetic element 92 fastened on the rear side 11 of the image carrier 6. Depending on the current flowing through the electromagnet 91, the magnetic element 92, and thus also the image carrier 6, is more or less pressed toward or away from the stop surface 12.

FIG. 13 shows a viewing device with a drive device 90′ in the case of which an electromagnet 91′ is provided in the vicinity of the edge of the image carrier 6 arranged such that it can be displaced laterally. The magnetic (or magnetizable) element 92′ assigned to the electromagnet 91′ is located in the lateral holders 34′, 35′ of the image carrier 6, or is formed itself thereby.

Furthermore, the drive devices can be fluidic drive devices, flexible pressure containers of cushion-shaped design (pressure cushions) for example, serving to change the position of the image carrier. In this case, the image carrier can be driven both from the rear side and from the front side of the image carrier, driving being possible by utilizing both a variable overpressure and a variable underpressure.

Two corresponding exemplary embodiments are shown in FIGS. 14 and 15.

In the case of the exemplary embodiment illustrated in FIG. 14, the image carrier 6 is driven by a “pressure cushion” 100 arranged at the front. This is formed substantially by the flexible image carrier 6 itself and the front wall 2 of the viewing device, the front wall 2 being closed in the region of the viewing opening 5 and consisting of a transparent material. The “pressure cushion” 100 is connected via at least one pressure line (not illustrated) to a pressure control device (likewise not illustrated) that can, for example, be arranged outside the viewing device and generates a prescribed pressure, indicated by arrows 110, in the pressure cushion 100.

In the case of the exemplary embodiment illustrated in FIG. 15, the image carrier 6 is driven from its rear side with the aid of a separate pressure cushion 100′. The latter acts on the image carrier 6 via an additional actuator 101. In this case, the pressure cushion 100′ is connected via a pressure line 102 to a pressure control device 103 arranged inside the viewing device.

Both a gas (for example air) and a liquid can be used as fluid of the drive device for changing the position of the image carrier.

List of Reference Numerals
1 Viewing device
2 Front wall
3 Rear wall
4 Housing
5 Viewing opening
6 Image carrier
7 Image, screen film, film
8-8^{IV} Drive device
9 Drive
10 Actuator
11 Rear side (image carrier)
12 Stop surface, holding device
12′ Rear side of the stop surface
13 Slot-shaped opening
14 Edge region (image carrier)
15 Inner side (front wall)
16 Cover film
17 Axis of rotation
18 Eccentric, actuator
19 Adjusting wheel
20 Metal or plastic band, actuator
21 Guide
22 Holding device
23 Winding mechanism
24 Bowden cable
25 Core, actuator
26 Fastening device
27 Spindle drive, drive
28 Spindle nut, slide, actuator
29 Guide
30 Elastic element, foam rubber bearing
31 Holding device
32 Drive element, actuator
33 Element
34, 35 Holders
34′, 35′ Holders
36, 37 Spools
80 Drive device
81-83 Drives
84 Actuator
90, 90′ Drive devices
91, 91′ Electromagnets
92, 92′ Magnetic elements
100, 100′ Pressure container, pressure cushion
101 Actuator
102 Pressure line
103 Pressure control device
110 Arrows

1. A view with a housing having a front wall and a rear wall, the front wall having at least one viewing opening for viewing an image displayed in the interior of the housing on an image carrier, characterized in that in the housing at least one drive device; acting on the image carrier is provided in such a way that the position of the image carrier can be changed with reference to the viewing opening from a first end position into a second end position, and vice versa, the image remaining visible from various perspectives.

2. The viewing device as claimed in claim 1, characterized in that the image carrier is supported inside the housing in such a way that it can be displaced as a whole by the drive device away from the viewing opening or toward the viewing opening.

3. The viewing device as claimed in claim 1, characterized in that at least two opposite edge regions of the image carrier are respectively held by a holding device of rotary design in such a way that in the event of simultaneous rotation of the holding devices in an opposite sense of rotation the curvature of the image carrier can be changed with reference to the viewing opening.

4. The viewing device as claimed in claim 1, characterized in that at least two opposite edge regions of the image carrier are respectively held by a holding device, said holding device being designed in a fashion capable of mutual displacement in the direction of the longitudinal axis of the image carrier in such a way that in the event of displacement of the two holding devices toward one another the curvature of the image carrier can be changed with reference to the viewing opening.

5. The viewing device as claimed in claim 1, characterized in that provided on the side of the edge regions of the image carrier facing the viewer of the viewing device are two holders that can be mutually displaced in a fashion substantially perpendicular to the longitudinal axis of the image carrier and between which there is clamped a transparent plate-shaped element that, when being used properly, presses on the outside against the image carrier so that the curvature of the image carrier changes with reference to the viewing opening into the interior of the housing of the viewing device.

6. The viewing device as claimed in claim 1, characterized in that at least two opposite edge regions of the image carrier are respectively held by a holding device in such a way that the curvature of the image carrier can be changed with reference to the viewing opening by a drive device acting in the middle region on the image carrier.

7. The viewing device as claimed in claim 1, characterized in that the holding devices have guides which guide the edge regions of the image carrier that are displaced laterally during a change in curvature.

8. The viewing device as claimed in claim 1, characterized in that the edge regions of the image carrier are connected to the holding devices via elastic connecting means.

9. The viewing device as claimed in claim 1, characterized in that the drive device comprises at least three drives, two drives respectively being fastened in the edge region of the image carrier, and one drive being fastened on the image carrier in the middle region thereof, the drives substantially effecting a displacement of the image carrier perpendicular to the longitudinal axis of the image carrier.

10. The viewing device as claimed in claim 9, characterized in that the drive acting on the middle region of the image carrier acts on the image carrier via a plate-shaped actuator.

11. The viewing device as claimed in claim 1, characterized in that the drive device comprises at least one electric motor drive with a downstream actuator acting on the respective image carrier.

12. The viewing device as claimed in claim 11, characterized in that the drive device comprises as actuator a zoom mechanism acting on the image carrier.

13. The viewing device as claimed in claim 11, characterized in that the drive device comprises as actuator a displaceable slide acting on the lower and/or upper edge region of the image carrier.

14. The viewing device as claimed in claim 11, characterized in that the drive device is an eccentric drive.

15. The viewing device as claimed in claim 6, characterized in that the drive device is an eccentric drive that can be actuated manually from outside the housing by means of an adjusting wheel.

16. The viewing device as claimed in claim 6, characterized in that the drive device comprises a stiff, flat metal or plastic band that is guided through a guide fastened on the rear side of the image carrier and is fastened at one of its ends in a holding device fixed to the housing, and is arranged at its other end such that it can be wound up and/or unwound by a winding mechanism.

17. The viewing device as claimed in claim 6, characterized in that the drive device is a Bowden cable, the core of the Bowden cable being connected to a fastening device arranged on the rear side of the image carrier.

18. The viewing device as claimed in claim 1, characterized in that provided in the housing is a stop surface that is arranged in the vicinity of the rear wall and against which the image carrier bears in a form-fitting fashion in its first end position.

19. The viewing device as claimed in claim 1, characterized in that the front wall is designed as front stop surface of the image carrier against which the image carrier bears in a form-fitting fashion in its second end position.

20. The viewing device as claimed in claim 1, characterized in that the image carrier is a flat screen consisting of elastic material.

21. The viewing device as claimed in claim 1, characterized in that the image carrier can be illuminated by at least one light source that can be arranged inside the housing.

22. The viewing device as claimed in claim 18, characterized in that the image carrier consists of a transparent material and can be illuminated from the rear side of the housing.

23. The viewing device as claimed in claim 1, characterized in that the image carrier is designed as an irradiatable or transirradiatable image projection surface.

24. The viewing device as claimed in claim 23, characterized in that the image projection surface is a flexible projection screen, plastic surface or mirror surface.

25. The viewing device as claimed in claim 1, characterized in that the drive device comprises at least one electromagnet that acts on at least one magnetic or magnetizable element that either is formed by the image carrier itself, or is arranged either on the rear side of the image carrier or on the lateral edge regions of the image carrier.

26. The viewing device as claimed in claim 1, characterized in that the drive device is a fluidic drive with a pressure container of cushion-shaped design, the pressure container at least one flexibly designed wall with the aid of which it acts on the image carrier in order to change the position of the latter either directly or via an actuator.

27. The viewing device as claimed in claim 26, characterized in that the pressure container is arranged at the front with reference to the image carrier, the image carrier and the front wall of the viewing device forming side walls of the pressure container, and the front wall being of closed design in the region of the viewing opening and consisting of a transparent material.

28. The viewing device as claimed in claim 26, characterized in that the pressure container is a cushion-shaped container that is arranged on the rear side of the image carrier and acts on the image carrier in order to change the position of the image carrier via an additional actuator.
